(19) United States
(12) Patent Application Publication
(10) Pub. No.: US 2024/0394106 A1
(43) Pub. Date: Nov. 28, 2024

(54) METHOD, APPARATUS, AND ELECTRONIC DEVICE FOR RESOURCE PROCESSING, COMPUTER-READABLE STORAGE MEDIUM, AND COMPUTER PROGRAM PRODUCT

(71) Applicant: Tencent Technology (Shenzhen) Company Limited, Shenzhen (CN)

(72) Inventor: Dan LI, Shenzhen (CN)

(21) Appl. No.: 18/797,247

(22) Filed: Aug. 7, 2024

Related U.S. Application Data
(63) Continuation of application No. PCT/CN2023/128288, filed on Oct. 31, 2023.

(30) Foreign Application Priority Data
Dec. 20, 2022 (CN) 202211643667.4

(51) Int. Cl. G06F 9/50

(52) U.S. Cl. CPC G06F 9/5027

(57) ABSTRACT

A method for optimizing computing resource is performed by an electronic device. The method includes: determining a current resource quantity of a first resource based on current load data of the first resource and a target resource quantity of the first resource in connection with performing a computing task; scaling the first resource based on a comparison of the target resource quantity and the current resource quantity of the first resource; and scaling a second resource based on a scheduling state of the scaled first resource, wherein the scheduling state of the first resource refers to a scheduling condition of the first resource on the second resource, including that scheduling has been completed on the second resource and scheduling has not been completed on the second resource.

### CROSS-REFERENCE TO RELATED APPLICATIONS

This application is a continuation application of PCT Patent Application No. PCT/CN2023/128288, entitled “VIRTUAL OBJECT INTERACTION METHOD AND APPARATUS, DEVICE, STORAGE MEDIUM, AND PROGRAM PRODUCT” filed on Oct. 31, 2023, which is based on and claims priority to Chinese Patent Application No. 202211643667.4, entitled “VIRTUAL OBJECT INTERACTION METHOD AND APPARATUS, DEVICE, STORAGE MEDIUM, AND PROGRAM PRODUCT” filed on Dec. 20, 2022, both of which are incorporated herein by reference in their entirety.

### FIELD OF THE TECHNOLOGY

This application relates to resource processing technologies in the field of computer application, and in particular, to a method, an apparatus, and an electronic device for resource processing, a computer-readable storage medium, and a computer program product.

### BACKGROUND OF THE DISCLOSURE

In an application (APP) that carries a plurality of computing tasks, a quantity of the computing tasks usually changes. To ensure stability of the APP, a preset resource quantity is often twice a corresponding resource quantity at a peak of the computing tasks, resulting in resource redundancy and resource waste. In this way, a resource utilization rate is affected.

### SUMMARY

Embodiments of this application provide a method, an apparatus, and an electronic device for resource processing, a computer-readable storage medium, and a computer program product, so as to increase a resource utilization rate.

Technical solutions in the embodiments of this application are implemented as follows.

An embodiment of this application provides a method for optimizing computing resource performed by an electronic device, and the method including:
determining a current resource quantity of a first resource based on current load data of the first resource and a target resource quantity of the first resource in connection with performing a computing task;
scaling the first resource based on a comparison of the target resource quantity and the current resource quantity of the first resource, the scaling the first resource comprising upscaling the first resource or downscaling the first resource; and
scaling a second resource based on a scheduling state of the scaled first resource, the scaling a second resource comprising upscaling the second resource or downscaling the second resource, wherein the scheduling state of the first resource refers to a scheduling condition of the first resource on the second resource, including that scheduling has been completed on the second resource and scheduling has not been completed on the second resource.

An embodiment of this application provides an electronic device, including:
a memory, configured to store computer-executable instructions; and
a processor, configured to implement the method for optimizing computing resource provided in the embodiments of this application when executing the computer-executable instructions stored in the memory.

An embodiment of this application provides a non-transitory computer-readable storage medium, having computer-executable instructions stored therein, the computer-executable instructions, when executed by a processor of an electronic device, being configured for implementing the method for optimizing computing resource provided in the embodiments of this application.

The embodiments of this application have at least the following beneficial effects. When the first resource is scheduled to the second resource, and the computing task is performed through the first resource, the target resource quantity is determined based on the current load data of the first resource, the scaling of the first resource is implemented based on the target resource quantity and the current resource quantity of the first resource, and the second resource is scaled based on the scheduling state of the scaled first resource as a linked operation, thereby implementing automatic scaling of the first resource and the second resource, so that the computing task can match the first resource and the second resource in quantity. Therefore, resource redundancy and resource waste are reduced, thereby reducing resource consumption and increasing the resource utilization rate.

### BRIEF DESCRIPTION OF THE DRAWINGS

FIG. 1 is a schematic diagram of an architecture of a system for resource processing according to an embodiment of this application.

FIG. 2 is a schematic structural diagram of a server in FIG. 1 according to an embodiment of this application.

FIG. 3 is a schematic flowchart 1 of a method for resource processing according to an embodiment of this application.

FIG. 4 is a schematic flowchart 2 of a method for resource processing according to an embodiment of this application.

FIG. 5 is a schematic flowchart 3 of a method for resource processing according to an embodiment of this application.

FIG. 6 is a schematic flowchart 4 of a method for resource processing according to an embodiment of this application.

FIG. 7 is a schematic flowchart of upscaling a second resource according to an embodiment of this application.

FIG. 8 is a diagram of an exemplary server architecture according to an embodiment of this application.

FIG. 9 is a schematic diagram of a server deployment environment according to an embodiment of this application.

FIG. 10 is a schematic diagram of exemplary load reporting according to an embodiment of this application.

FIG. 11 is a schematic diagram of upscaling an exemplary virtual machine according to an embodiment of this application.

FIG. 12 is an interaction diagram of upscaling an exemplary virtual machine according to an embodiment of this application.

FIG. 13 is an interaction diagram of downscaling an exemplary virtual machine according to an embodiment of this application.

FIG. 14 is a schematic diagram of exemplary lossless downscaling according to an embodiment of this application.

FIG. 15 is a schematic diagram of an exemplary lossless downscaling process according to an embodiment of this application.

### DESCRIPTION OF EMBODIMENTS

To make objectives, technical solutions, and advantages of this application clearer, this application is described in further detail with reference to drawings. The described embodiments are not to be construed as a limitation on this application. All other embodiments obtained by a person of ordinary skill in the art without creative efforts fall within the protection scope of this application.

In the following description, the involved expression “some embodiments” describes subsets of all possible embodiments, but the expression “some embodiments” may be the same subset or different subsets of all the possible embodiments, and may be combined with each other without conflict.

In the following description, the involved term “first/second” is configured for distinguishing between similar objects rather than representing a specific order of objects. The term “first/second” may be transposed in the specific order or a sequence when allowed, so that the embodiments of this application described herein can be implemented in an order other than those illustrated or described herein.

Unless otherwise defined, meanings of all technical and scientific terms used in the embodiments of this application are the same as those usually understood by a person skilled in the technical field of this application. Terms used in the embodiments of this application are merely intended to describe the objectives of the embodiments of this application, and are not intended to limit this application.

Before the embodiments of this application are further described in detail, terms involved in the embodiments of this application are described. The terms involved in the embodiments of this application are applicable to the following explanations.

1) Artificial Intelligence (AI) is a theory, a method, a technology, and an application system that uses a digital computer or a machine controlled by the digital computer to simulate, extend, and expand human intelligence, perceive the environment, acquire knowledge, and use knowledge to obtain an optimal result. A computing task in the embodiments of this application may be an AI task.

2) Machine learning (ML) is a multi-disciplinary interdiscipline, involving a plurality of disciplines such as the probability theory, statistics, approximation theory, convex analysis, algorithm complexity theory, and the like. ML specializes in how a computer simulates or realizes learning behaviors of humans to obtain new knowledge or skills, and reorganizes existing knowledge structures to keep improving performance thereof. ML is the core of AI and a fundamental way to make computers intelligent, and ML is applied to various fields of AI. ML generally includes technologies such as an artificial neural network, a confidence network, reinforcement learning, transfer learning, and inductive learning. The computing task in the embodiments of this application may be an ML task in AI.

3) The artificial neural network is a mathematical model that imitates a structure and functions of a biological neural network. An exemplary structure of the artificial neural network includes a graph convolutional network (GCN, a neural network configured to process data of a graph structure), a deep neural network (DNN), a convolutional neural network (CNN), a recurrent neural network (RNN), a neural state machine (NSM), and a phase-functional neural network (PFNN), and the like. In the embodiment of this application, a target resource quantity may be determined based on current load data through the artificial neural network.

4) Virtual scene: It refers to a virtual scene presented (or provided) by an application (APP) when running on a terminal device, or may refer to a virtual scene played by receiving audio and video information transmitted by a cloud server. The APP runs on the cloud server. In addition, the virtual scene may be a simulation environment for the real world, or may be a semi-simulation and semi-fiction virtual environment, and may further be a purely fictional virtual environment. The virtual scene may be any one of a two-dimensional virtual scene, a 2.5-dimensional virtual scene, or a three-dimensional virtual scene, and the dimension of the virtual scene is not limited in the embodiments of this application. For example, the virtual scene may include a virtual sky, a virtual land, a virtual ocean, and the like. The virtual land may include environmental elements such as a virtual desert and a virtual city. A user may control a virtual object to move in the virtual scene.

5) Virtual object: The virtual objects are images of various people and things that may interact in a virtual scene, or movable objects in the virtual scene. The movable objects may be a virtual character, a virtual animal, a virtual vehicle, a cartoon character, and the like, for example, a character and an animal presented in a virtual scene. The virtual object may be a virtual image for representing a user in a virtual scene. The virtual scene may include a plurality of virtual objects, and each virtual object has a shape and a volume in the virtual scene, and occupies some space in the virtual scene.

6) Cloud technology: It is a general term for a network technology, an information technology, an integration technology, a platform management technology, and an application technology based on application of a cloud computing business model, which may form a resource pool and be used on demand in a flexible and convenient manner. A method for resource processing provided in the embodiments of this application may be implemented through the cloud technology.

7) Operation: It is a manner of triggering a device to perform a process, for example, a clicking/tapping operation, a double clicking/tapping operation, a touch and hold operation, a sliding operation, a gesture operation, and a received triggering instruction. In addition, each operation in the embodiments of this application may be a single operation or a general term for a plurality of operations. Each operation in the embodiments of this application may be a touch operation, or may be a non-touch operation.

In an APP that carries a plurality of computing processes, a quantity of computing processes is often unstable. To improve stability of the APP, a preset resource quantity is often twice a corresponding resource quantity at a peak of the computing processes. In this way, resource consumption is increased.

Exemplarily, in an APP related to the virtual scene, a quantity of virtual battles involved changes in real time. To ensure normal operation of all of the virtual battles, more resources than required are generally used for implementation. In addition, the preset resource quantity is usually twice the corresponding resource quantity at the peak of the quantity of virtual battles. A great difference (greater than a quantity difference threshold) exists between the quantity of virtual battles at the peak and a quantity of virtual battles at the trough. In addition, for example, night is the peak of the virtual battles compared with daytime, and weekends or holidays are the peak of the virtual battles compared with weekdays, which are foreseeable peaks corresponding to a virtual battle quantity. An unforeseeable peak further exists. For example, during an operation activity, an unpredictable peak may occur during self-propagation of a virtual battle function among user accounts. As a result, more resources than required are often preset, resulting in resource redundancy and resource waste.

Based on this, the embodiments of this application provide a method, an apparatus, and an electronic device for resource processing, a computer-readable storage medium, and a computer program product, so as to reduce resource redundancy and resource waste, thereby reducing resource consumption and increasing a resource utilization rate. Exemplary application of an electronic device (which is referred to as a device for resource processing for short below) for resource processing provided in the embodiments of this application is described below. The device for resource processing provided in the embodiments of this application may be implemented as various types of terminals such as a smartphone, a smartwatch, a notebook computer, a tablet computer, a desktop computer, a smart home appliance, a set-top box, a smart on-board device, a portable music player, a personal digital assistant, a dedicated messaging device, an intelligent voice interaction device, a portable game device, and a smart speaker, or may be implemented as a server, and may further be implemented as a combination of the terminal and the server, which is not limited in the embodiments of this application. Exemplary application in which the device for resource processing is implemented as the server is described below.

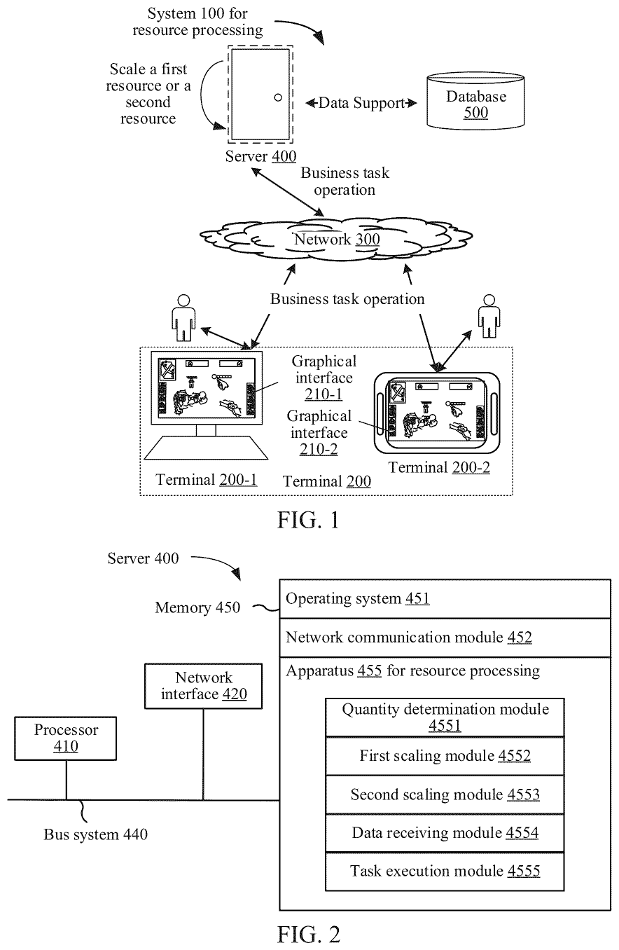

FIG. 1 is a schematic diagram of an architecture of a system for resource processing according to an embodiment of this application. As shown in FIG. 1, to support a resource processing APP, in a system 100 for resource processing, a terminal 200 (a terminal 200-1 and a terminal 200-2 that are exemplarily shown) is connected to a server 400 (which is referred to as a device for resource processing) through a network 300. The network 300 may be a wide area network, a local area network, or a combination thereof. In addition, the system 100 for resource processing further includes a database 500, configured to provide a data support to the server 400. FIG. 1 shows a case in which the database 500 is independent of the server 400. The database 500 may further be integrated in the server 400, which is not limited in this embodiment of this application.

The terminal 200 is configured to obtain a computing task operation through a graphical interface (a graphical interface 210-1 and a graphical interface 210-2 are exemplarily shown), and transmit the computing task operation to the server 400 through the network 300.

The server 400 is configured to: receive, through the network 300, the computing task operation transmitted by the terminal 200, obtain current load data of a first resource based on the computing task operation, and determine a target resource quantity of the first resource based on the current load data of the first resource, the first resource referring to a resource scheduling unit configured to perform a computing task; scale the first resource based on the target resource quantity and a current resource quantity of the first resource, the scaling the first resource including upscaling the first resource or downscaling the first resource; and scale a second resource based on a scheduling state of a scaled first resource, the second resource being configured for scheduling the first resource, and the scaling a second resource including upscaling the second resource or downscaling the second resource.

In some embodiments, the server 400 may be an independent physical server, or may be a server cluster formed by a plurality of physical servers or a distributed system, may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and AI platform, may also be a combination of the above, or the like. The terminal 200 may be a smartphone, a smartwatch, a notebook computer, a tablet computer, a desktop computer, a smart television, a set-top box, a smart onboard device, a portable music player, a personal digital assistant, a dedicated messaging device, a portable game device, a smart speaker, and the like, but is not limited thereto. The terminal and the server may be directly or indirectly connected through wired or wireless communication, which is not limited in this embodiment of this application.

FIG. 2 is a schematic structural diagram of a server in FIG. 1 according to an embodiment of this application. As shown in FIG. 2, a server 400 includes at least one processor 410, a memory 450, and at least one network interface 420. Components in the server 400 are coupled together through a bus system 440. The bus system 440 is configured to implement connection and communication between the components. In addition to a data bus, the bus system 440 further includes a power bus, a control bus, and a status signal bus. However, for clarity, various buses are marked as the bus system 440 in FIG. 2.

The processor 410 may be an integrated circuit chip with a signal processing capability, for example, a general processor, a digital signal processor (DSP), another programmable logic device, a discrete gate or a transistor logic device, a discrete hardware component, or the like. The general processor may be a microprocessor, any conventional processor, or the like.

The memory 450 may be removable, non-removable, or a combination thereof. An exemplary hardware device includes a solid-state memory, a hard disk drive, an optical disk drive, and the like. In some embodiments, the memory 450 includes one or more storage devices that are physically located away from the processor 410.

The memory 450 includes a volatile memory or a non-volatile memory, or may include both the volatile memory and the non-volatile memory. The non-volatile memory may be a read-only memory (ROM). The volatile memory may be a random access memory (RAM). The memory 450 described in this embodiment of this application is intended to include any suitable type of memory.

In some embodiments, the memory 450 can store data to support various operations. Examples of the data include a program, a module, and a data structure, or a subset or a superset thereof. An exemplary description is provided below.

An operating system 451 includes system programs configured to process various basic system services and perform hardware-related tasks, for example, a frame layer, a core library layer, and a driver layer, which are configured to implement various basic businesses and process hardware-based tasks.

A network communication module 452 is configured to arrive at another electronic device through one or more (wired or wireless) network interfaces 420. Exemplary network interfaces 420 include a Bluetooth interface, a wireless compatibility authentication (Wi-Fi) interface, a universal serial bus (USB) interface, and the like.

In some embodiments, an apparatus for resource processing provided in this embodiment of this application may be implemented by software. FIG. 2 shows an apparatus 455 for resource processing stored in the memory 450, which may be software in the form of programs and plug-ins, including the following software modules: a quantity determination module 4551, a first scaling module 4552, a second scaling module 4553, a data receiving module 4554, and a task execution module 4555. The modules are logical and therefore may be arbitrarily combined or further split based on implemented functions. Functions of the modules are to be described below.

In some embodiments, the apparatus for resource processing provided in the embodiments of this application may be implemented through hardware. In an example, the apparatus for resource processing provided in the embodiments of this application may be a processor in the form of a hardware decoding processor, which is programmed to perform the method for resource processing provided in the embodiments of this application. For example, the processor in the form of the hardware decoding processor may be one or more application specific integrated circuits (ASICs), a DSP, a programmable logic device (PLD), a complex programmable logic device (CPLD), a field-programmable gate array (FPGA), or another electronic element.

In some embodiments, the terminal or the server may implement the method for resource processing provided in the embodiments of this application by running a computer program. For example, the computer program may be a native program or a software module in an operating system, or may be a native APP, i.e., a program that needs to be installed in the operating system to run, for example, a resource scaling APP, or may be an applet, i.e., a program that only needs to be downloaded into a browser environment to run, and may further be an applet that can be embedded in any APP. In a word, the foregoing computer program may be an APP, a module, or a plug-in of any form.

The method for resource processing provided in the embodiments of this application is to be described below based on exemplary application and implementation of the device for resource processing provided in the embodiments of this application. In addition, the method for resource processing provided in the embodiments of this application is applied to various resource processing scenarios such as the cloud technology, AI, intelligent transportation, a vehicle, and a game.

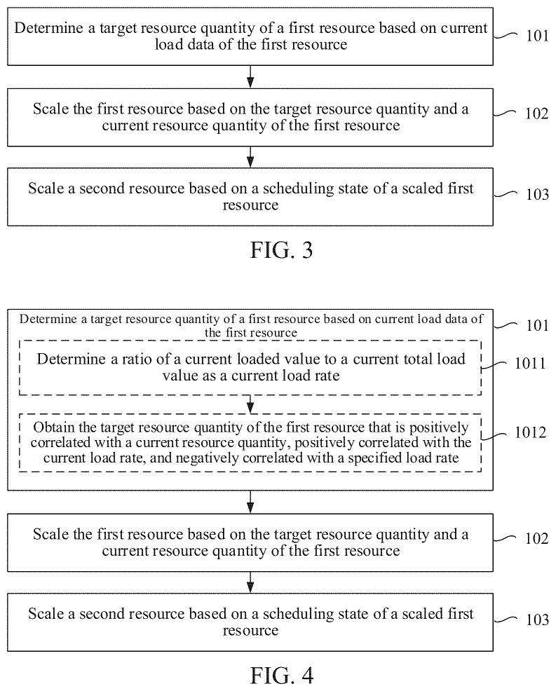

FIG. 3 is a schematic flowchart 1 of a method for resource processing according to an embodiment of this application. Operations in FIG. 3 are performed by a device for resource processing. A description is given below based on the operations shown in FIG. 3.

Operation 101: Determine a target resource quantity of a first resource based on current load data of the first resource.

In this embodiment of this application, the device for resource processing may obtain the current load data of the first resource. The current load data may be obtained through active collection, passive data reception, or a combination of the two, which is not limited in this embodiment of this application. Herein, since the first resource refers to a resource scheduling unit configured to perform a computing task (for example, a computing unit pod configured to deploy a computing process), and the current load data indicates resource usage of the first resource, the target resource quantity of the first resource matching a currently executed computing task can be determined through the current load data. In other words, the target resource quantity of the first resource refers to a quantity of first resources required by the currently executed computing task. The computing task refers to a task unit configured for performing a computing function, which may be a computing process, or may be a computing thread, may further be a computing process with a specified process quantity, and may further be a computing thread with a specified thread quantity, or a combination of the above, which is not limited in this embodiment of this application. In cloud computing, a point of delivery, or “pod”, is a module of network, compute, storage, and application components that work together to deliver networking services. The pod is a repeatable design pattern, and its components maximize the modularity, scalability, and manageability of data centers. Pods are often used as the basis for cloud computing services.

When the device for resource processing obtains the current load data through active collection, sub-load data of the first resource on each first service device may be obtained through a second service device, and the sub-load data respectively corresponding to all of the first resources may be combined into the current load data. The first service device is configured to perform at least one computing task through the first resource, and the second service device is configured to control the first service device. A correspondence between the first service device and the second service device is a many-to-one correspondence. The second service device is further configured to transmit the current load data to a business serving device. The business serving device is configured to determine a first resource corresponding to a new computing task based on the current load data. When the device for resource processing obtains the current load data through passive data reception, the current load data transmitted by the at least one first service device through the second service device is received. In addition, the current load data includes at least one of the following: a current resource quantity, a current total load value, and a current loaded value. The current resource quantity refers to a current quantity of first resources. The current total load value refers to a total resource value corresponding to the first resources, for example, a quantity of at least one of processors and memories corresponding to the first resources. The current loaded value refers to a used resource value corresponding to the first resource, for example, a quantity of the processors and the memories corresponding to the first resource which have been used.

Operation 102: Scale the first resource based on the target resource quantity and a current resource quantity of the first resource.

In this embodiment of this application, the device for resource processing can obtain the current resource quantity of the first resource. The current resource quantity may be obtained through the current load data, or may be obtained in the same manner as the current load data, which is not limited in this embodiment of this application. Herein, after the device for resource processing obtains the target resource quantity, the device for resource processing compares the target resource quantity with the current resource quantity to scale the first resource based on a comparison result between the target resource quantity and the current resource quantity.

The scaling the first resource includes upscaling the first resource or downscaling the first resource. The upscaling the first resource refers to increasing processing of the first resource, and the downscaling the first resource refers to reducing the processing of the first resource. In addition, during scaling of the first resource by the device for resource processing based on the comparison result between the target resource quantity and the current resource quantity, when the target resource quantity is greater than the current resource quantity, it indicates that a quantity of required first resources is greater than a quantity of current first resources. Therefore, the device for resource processing upscales the first resource. However, when the target resource quantity is less than the current resource quantity, it indicates that the quantity of required first resources is less than the quantity of current first resources. Therefore, the device for resource processing upscales the first resource. Moreover, when the target resource quantity is equal to the current resource quantity, it indicates that the quantity of required first resources is equal to the quantity of current first resources. Therefore, the device for resource processing cancels downscaling the first resource.

Operation 103: Scale a second resource based on a scheduling state of a scaled first resource.

In this embodiment of this application, since the first resource can support execution of the computing task only upon completion of scheduling on the second resource, the device for resource processing is further configured to scale the second resource based on the scheduling state of the scaled first resource after scaling the first resource.

The scheduling state of the first resource refers to a scheduling condition of the first resource on the second resource, including that scheduling has been completed on the second resource, which is referred to as a scheduled state herein, and may further include that scheduling has not been completed on the second resource, which is referred to as an unscheduled state herein. In addition, the second resource is configured for scheduling the first resource, and the second resource may be a virtual device (for example, a virtual machine), a physical device (for example, a physical machine), a combination of the virtual device and the physical device, or the like, which is not limited in this embodiment of this application. Herein, the scaling the second resource by the device for resource processing includes upscaling the second resource or downscaling the second resource. The upscaling the second resource refers to increasing processing of the second resource, and the downscaling the second resource refers to reducing the processing of the second resource. Moreover, during scaling of the second resource by the device for resource processing based on the scheduling state of the scaled first resource, when the scheduling state includes the unscheduled state, it indicates that the first resource that is not scheduled on the second resource exists, thereby upscaling the second resource. However, when the scheduling states of the scaled first resources are all the scheduled state, it indicates that each first resource among the scaled first resources has been scheduled on the second resource. Therefore, the second resource may be downscaled in this case.

When the first resource is scheduled to the second resource, and the computing task is performed through the first resource, the target resource quantity is determined based on the current load data of the first resource, the scaling of the first resource is implemented based on the target resource quantity and the current resource quantity of the first resource, and the second resource is scaled based on the scheduling state of the scaled first resource as a linked operation, thereby implementing automatic scaling of the first resource and the second resource, so that the current computing task can match the first resource and the second resource in quantity. Therefore, resource redundancy and resource waste are reduced, thereby reducing resource consumption and increasing the resource utilization rate.

FIG. 4 is a schematic flowchart 2 of a method for resource processing according to an embodiment of this application. Operations in FIG. 4 are performed by a device for resource processing. Referring to FIG. 4, in this embodiment of this application, when a current load data includes a current resource quantity, a current total load value, and a current loaded value, operation 101 in FIG. 3 may be implemented through operation 1011 and operation 1012. In other words, the device for resource processing determines a target resource quantity of a first resource based on the current load data of the first resource, including operation 1011 and operation 1012. The operations are respectively described below.

Operation 1011: Determine a ratio of the current loaded value to the current total load value as a current load rate.

In this embodiment of this application, the device for resource processing determines the current load rate based on the current total load value and the current loaded value, and then determines the target resource quantity based on the current load rate. Herein, the device for resource processing may determine the ratio of the current total load value to the current loaded value as the current load rate. The current load rate represents a load of the resource among the first resources, namely, resource usage corresponding to the first resource, for example, 40%. It is readily learned that the current load rate is positively correlated with a quantity of computing tasks. Therefore, the current load rate also indicates a current quantity of computing tasks.

Operation 1012: Obtain the target resource quantity of the first resource that is positively correlated with the current resource quantity, positively correlated with the current load rate, and negatively correlated with a specified load rate.

In this embodiment of this application, the device for resource processing can obtain the specified load rate. The specified load rate is a preset load rate threshold, for example, 30%, which is used as an optimal load rate. Herein, the device for resource processing determines, as the target resource quantity of the first resource, a value positively correlated with the current resource quantity, positively correlated with the current load rate, and negatively correlated with the specified load rate. For example, when the specified load rate is 30% and the current load rate is 40%, 30% <40% indicates a high load of executing the computing task, and the first resource needs to be increased to reduce the current load rate. Therefore, the obtained target resource quantity is greater than the current resource quantity.

The specified load rate may be determined based on execution of the computing task, and the execution of the computing task may be determined through at least one of execution efficiency, feedback data after the execution, and a performance indicator during the execution. The execution of the computing task represents execution quality of the computing task. The specified load rate is negatively correlated with the execution quality. In other words, when the execution quality is high (greater than a first quality threshold), the device for resource processing increases a current specified load rate. However, when the execution quality is low (less than a second quality threshold), the device for resource processing decreases the current specified load rate. In this way, automatic adjustment of the specified load rate is implemented.

In this embodiment of this application, after operation 1011, a process of determining whether to trigger the scaling of the first resource is further included. In other words, after the device for resource processing determines the current load rate based on the current total load value and the current loaded value, the method for resource processing further includes: obtaining, by the device for resource processing, a load rate comparison result between the current load rate and a specified load rate range. Correspondingly, in operation 1012, the obtaining, by the device for resource processing, the target resource quantity of the first resource that is positively correlated with the current resource quantity, positively correlated with the current load rate, and negatively correlated with a specified load rate includes: obtaining, by the device for resource processing, the target resource quantity of the first resource that is positively correlated with the current resource quantity, positively correlated with the current load rate, and negatively correlated with the specified load rate when the load rate comparison result indicates that the current load rate is outside the specified load rate range; and ending a process of determining the target resource quantity when the load rate comparison result indicates that the current load rate is within the specified load rate range.

The device for resource processing may determine, by directly determining the target resource quantity based on the current load rate, whether to trigger scaling of the first resource, and may further determine, through the current load rate and the specified load rate range, whether to trigger the scaling of the first resource, which is not limited in this embodiment of this application. In addition, when the device for resource processing determines, through the current load rate and the specified load rate range, whether to trigger the scaling of the first resource, the scaling of the first resource is ended if the current load rate is within the specified load rate range. However, if the current load rate is outside the specified load rate range, the scaling of the first resource is triggered.

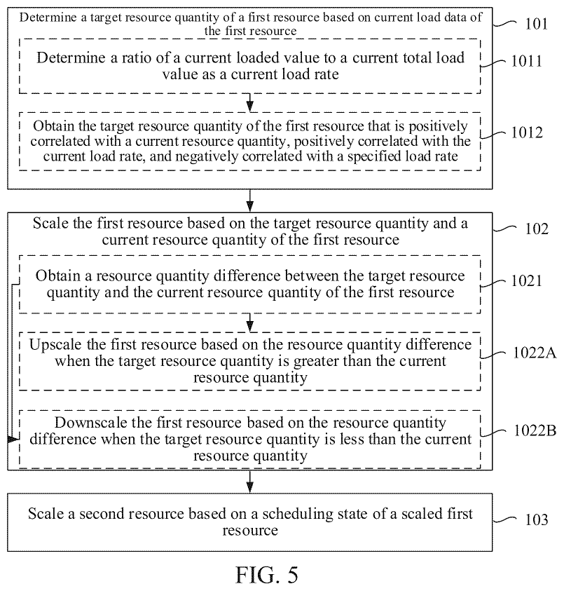

FIG. 5 is a schematic flowchart 3 of a method for resource processing according to an embodiment of this application. Operations in FIG. 5 are performed by a device for resource processing. Referring to FIG. 5, in this embodiment of this application, the device for resource processing scales a first resource based on a target resource quantity and a current resource quantity of the first resource in operation 102 in FIG. 3, including operation 1021, operation 1022A, and operation 1022B. The operations are respectively described below.

Operation 1021: Obtain a resource quantity difference between the target resource quantity and the current resource quantity of the first resource.

The resource quantity difference is a difference between the target resource quantity and the current resource quantity, which may be a vector or a scalar, which is not limited in this embodiment of this application.

Operation 1022A: Upscale the first resource based on the resource quantity difference when the target resource quantity is greater than the current resource quantity.

In this embodiment of this application, when the target resource quantity is greater than the current resource quantity, it indicates that required first resources are more than the existing first resource, so that the device for resource processing determines to upscale the first resource. In addition, when the resource quantity difference is the scalar, the resource quantity difference is a quantity of to-be-upscaled first resources. Therefore, the device for resource processing upscales the first resources with the resource quantity difference.

Operation 1022B: Downscale the first resource based on the resource quantity difference when the target resource quantity is less than the current resource quantity.

In this embodiment of this application, when the target resource quantity is less than the current resource quantity, it indicates that required first resources are fewer than the existing first resource, so that the device for resource processing determines to downscale the first resource. In addition, when the resource quantity difference is the scalar, the resource quantity difference is a quantity of to-be-downscaled first resources. Therefore, the device for resource processing downscales the first resources with the resource quantity difference.

Operation 1022A and operation 1022B are opposite operations. One of operation 1022A and operation 1022B is selected to perform. Operation 1022B is not performed when operation 1022A is performed, and operation 1022A is not performed when operation 1022B is performed.

In operation 1022B of FIG. 5 of this embodiment of this application, the downscaling, by the device for resource processing, the first resource based on the resource quantity difference includes: determining, by the device for resource processing, each to-be-downscaled first resource based on the resource quantity difference; and performing the following process for each to-be-downscaled first resource: deleting the to-be-downscaled first resource when a computing task quantity corresponding to the to-be-downscaled first resource is less than a specified quantity.

When the device for resource processing determines to downscale the first resource based on the resource quantity difference, the quantity of to-be-downscaled first resources is the resource quantity difference. For each to-be-downscaled first resource among the first resources with the resource quantity difference, based on a comparison result of the computing task quantity corresponding to the to-be-downscaled first resource and the specified quantity (for example, 1), it is determined whether to delete the to-be-downscaled first resource. Herein, when the device for resource processing determines that the computing task quantity is less than the specified quantity, the to-be-downscaled first resource is deleted. However, when the computing task quantity is greater than or equal to the specified quantity, a state of the to-be-downscaled first resource is adjusted to a first scheduling stop state, and when the computing task quantity is reduced to less than the specified quantity by adjusting the state of the to-be-downscaled first resource to the first scheduling stop state, the to-be-downscaled first resource is deleted. It is readily learned that the computing task quantity being less than the specified quantity indicates that the first resource is not scheduled by a second resource.

The deletion of the to-be-downscaled first resource is triggered only when the computing task quantity is less than the specified quantity. The computing task quantity may be obtained through active collection, passive data reception, or a combination of the two, which is not limited in this embodiment of this application. For example, the computing task quantity may be collected from the first service device, or may be data transmitted by the first service device. In addition, in the first scheduling stop state, the scheduling of the computing task for the first resource is stopped, so that each time a computing task is executed, the computing task quantity is reduced by one. Therefore, the first scheduling stop state is configured for reducing the computing task quantity.

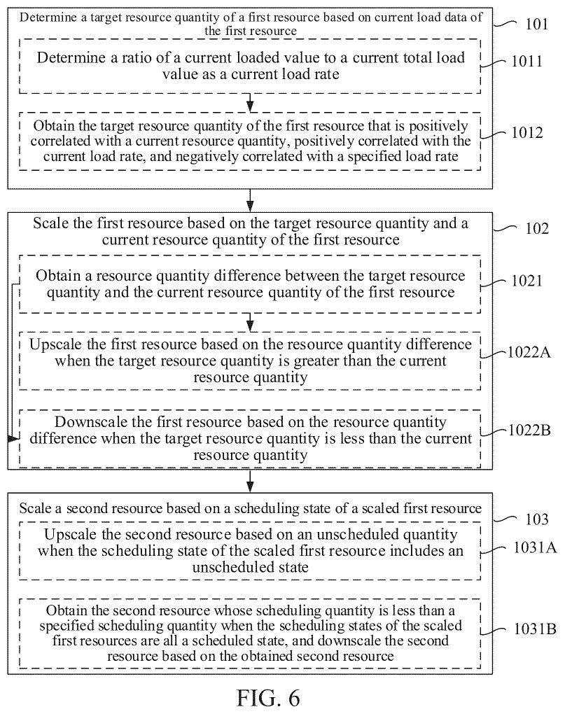

FIG. 6 is a schematic flowchart 4 of a method for resource processing according to an embodiment of this application. Operations in FIG. 6 are performed by a device for resource processing. Referring to FIG. 6, in this embodiment of this application, the device for resource processing scales a second resource based on a scheduling state of a scaled first resource in operation 103 in FIG. 3, including operation 1031A and operation 1031B. The operations are respectively described below.

Operation 1031A: Upscale the second resource based on an unscheduled quantity when the scheduling state of the scaled first resource includes an unscheduled state.

When the scheduling state of the scaled first resource includes the unscheduled state, the device for resource processing determines a quantity of to-be-upscaled second resources based on the unscheduled quantity, and upscales the second resource based on the quantity of to-be-upscaled second resources. The unscheduled quantity refers to a quantity of first resources in the unscheduled state.

Operation 1031B: Obtain the second resource whose scheduling quantity is less than a specified scheduling quantity when the scheduling states of the scaled first resources are all a scheduled state, and downscale the second resource based on the obtained second resource.

The scheduling quantity refers to a quantity of first resources scheduled on the second resource. The device for resource processing determines, based on a comparison result between the scheduled quantity and the specified scheduling quantity, whether to downscale the second resource. When the second resource whose scheduling quantity is less than the specified scheduling quantity is obtained, the device for resource processing deletes the second resource to downscale the second resource. However, when the second resource whose scheduling quantity is less than the specified scheduling quantity (for example, 1) is not obtained, namely, the scheduling quantity of any second resource is greater than or equal to the specified scheduling quantity, in this case, the device for resource processing stops downscaling the second resource.

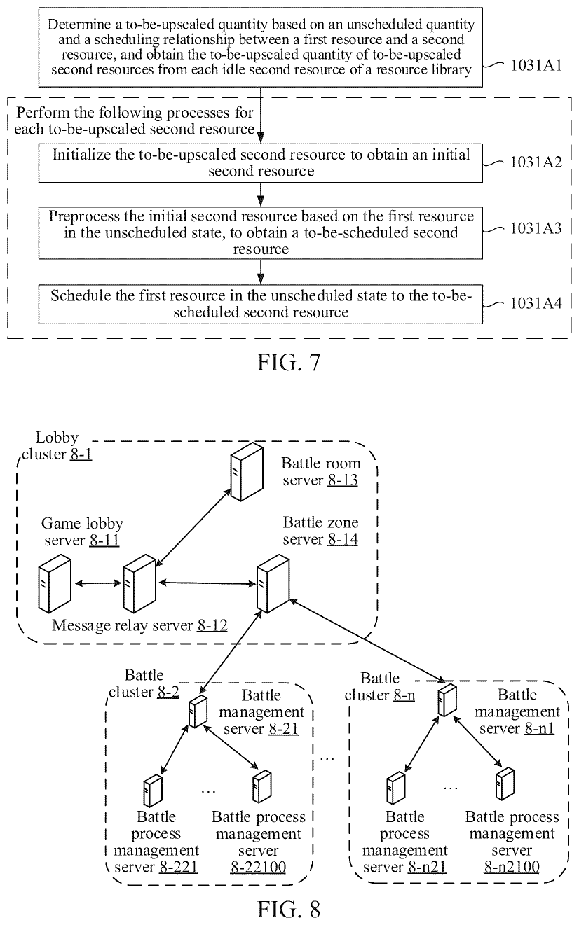

FIG. 7 is a schematic flowchart of upscaling a second resource according to an embodiment of this application. Operations in FIG. 7 are performed by a device for resource processing. Referring to FIG. 7, in this embodiment of this application, the device for resource processing upscales the second resource based on the unscheduled quantity in operation 1031A in FIG. 6, including operation 1031A1 to operation 1031A4. The operations are respectively described below.

Operation 1031A1: Determine a to-be-upscaled quantity based on the unscheduled quantity and a scheduling relationship between the first resource and the second resource, and obtain the to-be-upscaled quantity of to-be-upscaled second resources from each idle second resource of a resource library.

The to-be-upscaled quantity refers to a quantity of to-be-upscaled second resource. The scheduling relationship between the first resource and the second resource is, for example, a one-to-one relationship, a one-to-many relationship, and a scheduling relationship combined with a regional scheduling strategy. Herein, the resource library includes each idle second resource. The device for resource processing obtains the to-be-upscaled quantity of idle second resources from the resource library, and determines the to-be-upscaled quantity of obtained idle second resources as the to-be-upscaled quantity of to-be-upscaled second resources.

For each to-be-upscaled second resource, the following process is performed (operation 1031A2 to operation 1031A4).

Operation 1031A2: Initialize the to-be-upscaled second resource to obtain an initial second resource.

Each to-be-upscaled second resource obtained by the device for resource processing from the resource library is in an unavailable state. Therefore, the device for resource processing initializes the to-be-upscaled second resource to convert the to-be-upscaled second resource from the unavailable state into an available state. Herein, the to-be-upscaled second resource in the available state is the initial second resource. The initialization is, for example, system reinstallation, joining a second resource cluster (a cluster formed by the second resources already exists currently) through components, setting of system parameters, and generation of a directory.

Operation 1031A3: Preprocess the initial second resource based on the first resource in the unscheduled state, to obtain a to-be-scheduled second resource.

In this embodiment of this application, the device for resource processing determines the to-be-scheduled first resource in the unscheduled state for the initial second resource, and preprocesses the initial second resource for the to-be-scheduled first resource in the unscheduled state, so that the to-be-scheduled first resource in the unscheduled state can be scheduled to the initial second resource. The to-be-scheduled second resource refers to the preprocessed initial second resource. The preprocessing is, for example, downloading a mirror image of the to-be-scheduled first resource in the unscheduled state.

Operation 1031A4: Schedule the first resource in the unscheduled state to the to-be-scheduled second resource.

The device for resource processing schedules the first resource in the unscheduled state to the to-be-scheduled second resource, and updates the scheduling state of the scheduled first resource to a scheduled state.

In this embodiment of this application, in operation 1031B, the downscaling, by the device for resource processing, the second resource based on the obtained second resource includes: performing, by the device for resource processing, the following processes for each to-be-downscaled second resource among the obtained second resources: adjusting a state of the to-be-downscaled second resource to a second scheduling stop state; and moving the to-be-downscaled second resource to the resource library when a duration in the second scheduling stop state is greater than a specified duration.

The second scheduling stop state indicates a state in which scheduling of the first resource is stopped. The device for resource processing moves the to-be-downscaled second resource into the resource library as the idle second resource. In addition, when the device for resource processing obtains each to-be-downscaled second resource, the to-be-downscaled second resource is moved into the resource library only when it is determined that the scheduling quantity of the second resource is still less than the specified scheduling quantity after the duration in the second scheduling stop state is greater than the specified duration. In this way, a scaling frequency can be reduced, so that resource consumption of downscaling can be reduced, and stability of the execution of the computing task can be improved during network jittering.

In this embodiment of this application, the computing task includes at least one of the following: a virtual battle in a virtual scene and a transaction task. The method for resource processing further includes: obtaining, by the device for resource processing, the computing task based on a computing task operation; associating the computing task with the first resource; and performing the computing task based on scheduling of the first resource on the second resource.

When the computing task is the virtual battle, the virtual battle may be concurrent, and a quantity of the virtual battles changes in real time. Therefore, linked automatic scaling is performed on the first resource and the second resource through the method for resource processing provided in the embodiments of this application, so as to improve stability of performing the virtual battle. Similarly, when the computing task is the transaction task, the transaction task may be concurrent, and a quantity of the transaction tasks changes in real time. Therefore, the linked automatic scaling is performed on the first resource and the second resource through the method for resource processing provided in the embodiments of this application, so as to improve stability of performing the transaction task.

Next, exemplary application of this embodiment of this application in an actual application scenario is to be described. The exemplary application describes a process of lossless automatic scaling of a resource in a game battle.

There are two types of game background services. One type is a game lobby service configured for handling all business logic before the game battle, and the other type is a game battle service configured for handling the business logic after the game enters the virtual battle. Generally, the game battle service is implemented through a game battle server. The game battle server is usually deployed in a cluster (set).

FIG. 8 is a diagram of an exemplary server architecture according to an embodiment of this application. As shown in FIG. 8, a lobby cluster 8-1 includes a game lobby server (Lobby) 8-11, a message relay server (Router) 8-12, a battle room server (Roomsvr) 8-13, and a battle zone server (Zonesvr) 8-14. The message relay server 8-12 is configured to relay a message between servers in the lobby cluster 8-1. The battle zone server 8-14 is configured to manage a plurality of battle management servers (DScenter) in a plurality of battle clusters. A battle management server 8-21 in a battle cluster 8-2, . . . , and a battle management server 8-n1 in a battle cluster 8-n (n is a positive integer greater than 2) are exemplarily shown. In addition, a battle process management server (DSagent) 8-221 to a battle process management server 8-22100 are further exemplarily shown in the battle cluster 8-2, and a battle process management server 8-n21 to a battle process management server 8-n2100 are further exemplarily shown in the battle cluster 8-n. Herein, the game battle server includes the DScenter and the DSagent.

In this embodiment of this application, automatic scaling of the resource in the game battle includes automatic scaling of a computing unit (Pod, referred to as a first resource) corresponding to a battle process and automatic scaling of a virtual machine (which is referred to as a second resource) configured to schedule the pod, which are respectively described below.

In this embodiment of this application, to implement the automatic scaling of the resource in the game battle, the battle process management server (DSagent) and the battle management server (DScenter) are deployed to the cloud to be controlled by a service orchestration system (for example, Kubernetes (K8s)). The DSagent is configured to create and recycle a battle process (DS). Each battle corresponds to one battle process, and at least one battle process may be run on one battle process management server. In addition, the DScenter deploys the DSagent by region.

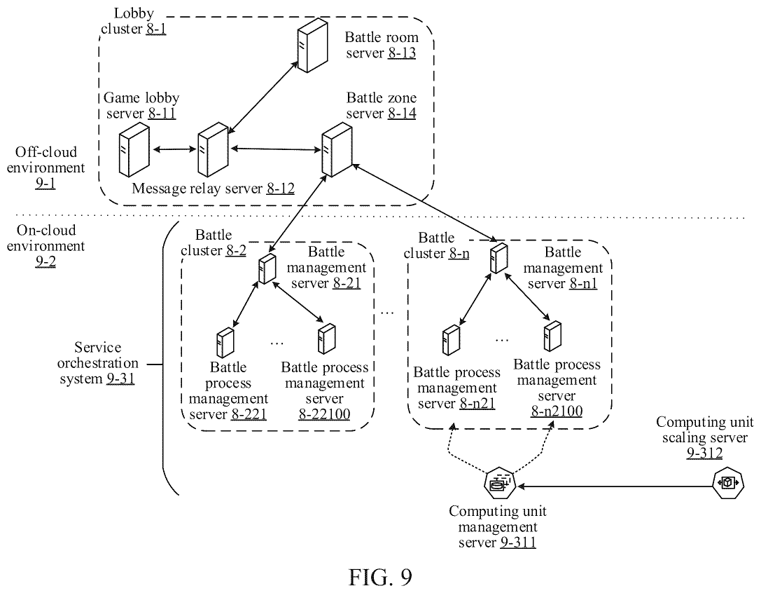

Based on FIG. 8, FIG. 9 is a schematic diagram of a server deployment environment according to an embodiment of this application. As shown in FIG. 9, each server in the lobby cluster 8-1 in FIG. 8 is deployed in an off-cloud environment 9-1, and servers in the battle cluster 8-2, . . . , and the battle cluster 8-n in FIG. 8 are deployed in an on-cloud environment 9-2 and hosted in a service orchestration system 9-31. In addition, the service orchestration system 9-31 further includes a computing unit management server (DSagent Statefulset) 9-311 and a computing unit scaling server (General Pod Autoscale, GPA) 9-312. The computing unit scaling server 9-312 may collect load data of the pod, calculate a required pod quantity (which is referred to as a target resource quantity) based on the load data of the pod, and transmit pod scaling information to the computing unit management server 9-311 based on the calculated required pod quantity, so that the computing unit management server 9-311 controls diffusion of the pod based on the pod scaling information.

In this embodiment of this application, the load data of the pod uploaded by the battle process management server through the battle management server is uniformly used, to ensure consistency of basis data.

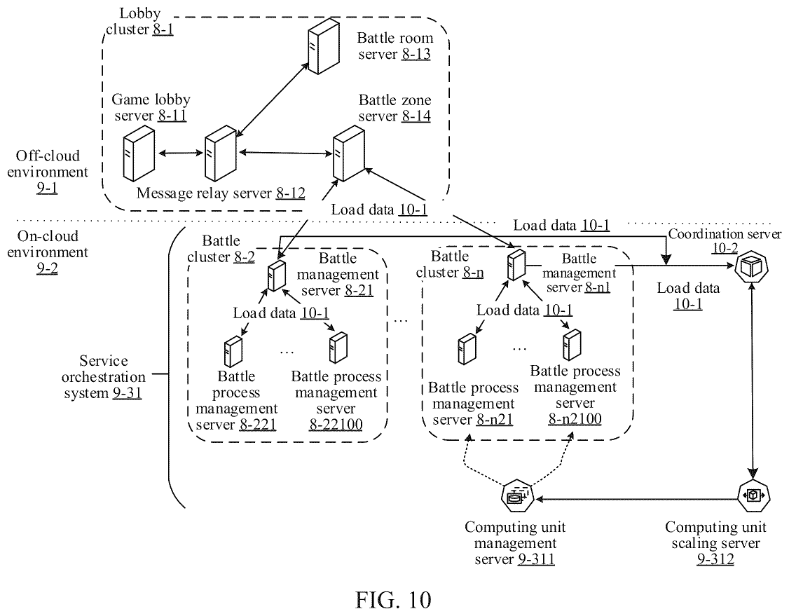

Based on FIG. 9, FIG. 10 is a schematic diagram of exemplary load reporting according to an embodiment of this application. As shown in FIG. 10, each virtual battle process management server obtains load data 10-1 (referred to as current load data) of a pod, and respectively transmits the load data 10-1 to a battle zone server 8-14 and a coordination server (DS-Coordinator) 10-2. The battle zone server 8-14 is configured to, when a virtual battle is started for a user account, determine a pod corresponding to a battle process of the virtual battle based on the load data 10-1. The coordination server 10-2 belongs to the service orchestration system 9-31, and the coordination server 10-2 is configured to calculate a required pod quantity c (referred to as a target resource quantity) based on the load data 10-1. The calculation process is shown in Equation (1).

$$\\ \begin{matrix}c = {c}_{1} \times {f}_{1} \times {f}_{2} & ( 1 )\end{matrix}$$

where c₁ is a current total quantity of pods (referred to as a current resource quantity), f₂ is a target load percentage (referred to as a specified load rate), which is a piece of configuration information that may be dynamically adjusted based on feedback of current battle quality in a configuration file of the coordination server, and f₁ is a current load percentage (referred to as a current load rate). The pod is scaled only when f₁ exceeds or is less than a specific threshold. The threshold is also configuration information, and may be dynamically adjusted based on an actual situation.

In addition, f₁ may be obtained through Equation (2). Equation (2) is shown below.

$$\\ \begin{matrix}{f}_{1} = {d}_{2} / {d}_{1} & ( 2 )\end{matrix}$$

where d₁ is a current total load (referred to as a current total load value) of the pod, and d₂ is a current used load (referred to as a current loaded value) of the pod. Herein, the load data 10-1 includes c₁, d₁, and d₂.

In this embodiment of this application, the computing unit scaling server 9-312 obtains the required pod quantity from the coordination server 10-2 through a hook (for example, a Web Hook), and upscales the pod and downscales the pod based on the current total quantity of pods.

During upscaling of the pod, if there are not enough virtual machines running the pod, the pod cannot run. In this case, the pod is in a pending state. When a virtual machine scaling server (Cluster Autoscaler, CA) can detect that the pod is in the pending state (referred to as an unscheduled state), the virtual machine is obtained from a cloud platform, the obtained virtual machine is added to the cluster, and the pod in the pending state is scheduled to the virtual machine.

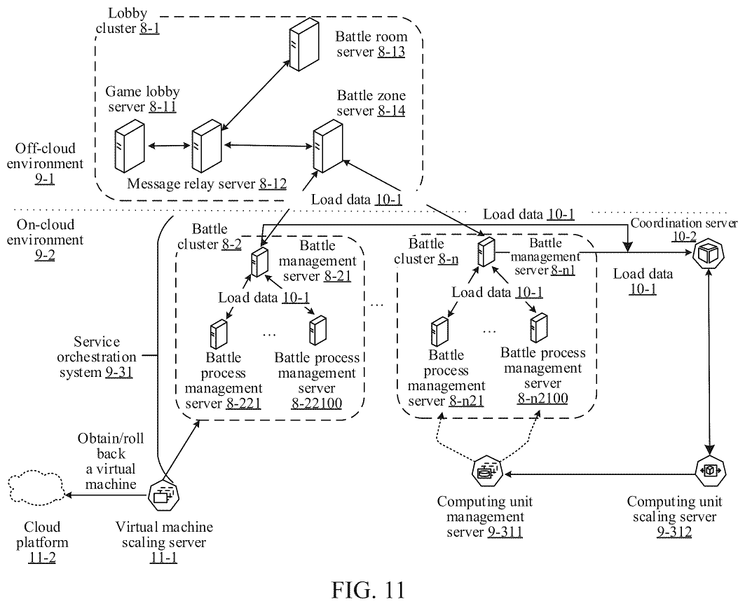

Based on FIG. 10, FIG. 11 is a schematic diagram of upscaling an exemplary virtual machine according to an embodiment of this application. As shown in FIG. 11, a virtual machine scaling server 11-1 obtains the virtual machine from a cloud platform 11-2 when detecting the pod in the pending state.

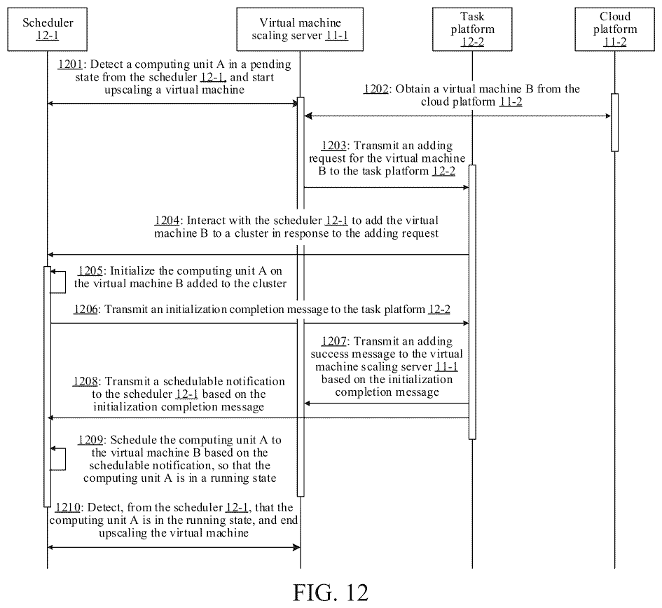

FIG. 12 is an interaction diagram of upscaling an exemplary virtual machine according to an embodiment of this application. As shown in FIG. 12, the virtual machine is upscaled by performing upscaling tasks among a scheduler 12-1, the virtual machine scaling server 11-1, a task platform 12-2, and the cloud platform 11-2 of the service orchestration system 9-31, including operation 1201 to operation 1210. The operations are respectively described below.

Operation 1201: The virtual machine scaling server 11-1 detects a computing unit A in a pending state from the scheduler 12-1, and starts upscaling the virtual machine.

Operation 1202: The virtual machine scaling server 11-1 obtains a virtual machine B (referred to as a to-be-upscaled second resource) from the cloud platform 11-2.

Operation 1203: The virtual machine scaling server 11-1 transmits an adding request for the virtual machine B to the task platform 12-2.

Operation 1204: The task platform 12-2 interacts with the scheduler 12-1 in response to the adding request, to add the virtual machine B to a cluster.

Operation 1205: The scheduler 12-1 initializes the computing unit A on the virtual machine B added to the cluster.

Operation 1206: The scheduler 12-1 transmits an initialization completion message to the task platform 12-2.

Operation 1207: The task platform 12-2 transmits an adding success message to the virtual machine scaling server 11-1 based on the initialization completion message.

Operation 1208: The task platform 12-2 transmits a schedulable notification to the scheduler 12-1 based on the initialization completion message.

Operation 1209: The scheduler 12-1 schedules the computing unit A to the virtual machine B based on the schedulable notification, so that the computing unit A is in a running state (referred to as a scheduled state).

Operation 1210: The virtual machine scaling server 11-1 detects, from the scheduler 12-1, that the computing unit A is in the running state, and ends upscaling the virtual machine.

In addition, the virtual machine scaling server 11-1 in FIG. 11 is further configured to perform a downscaling task to return the virtual machine to the cloud platform 11-2. In other words, the virtual machine scaling server 11-1 rolls back the virtual machine that does not run the pod to the cloud platform 11-2 when detecting the virtual machine that does not run the pod.

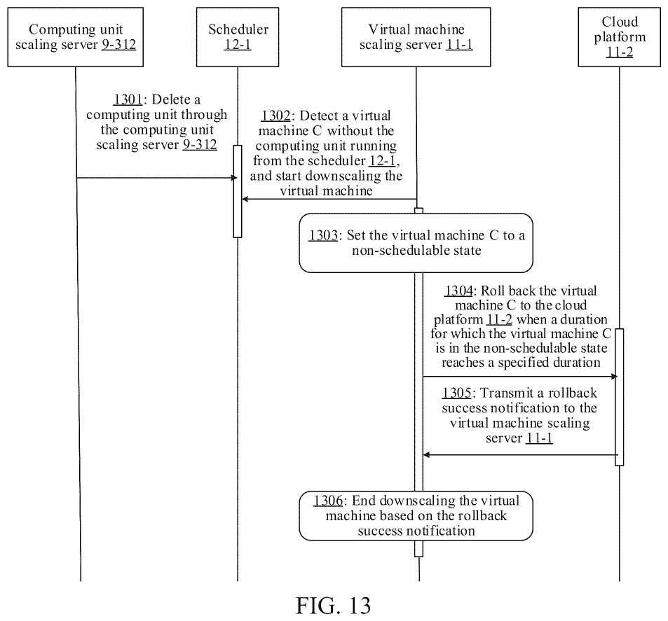

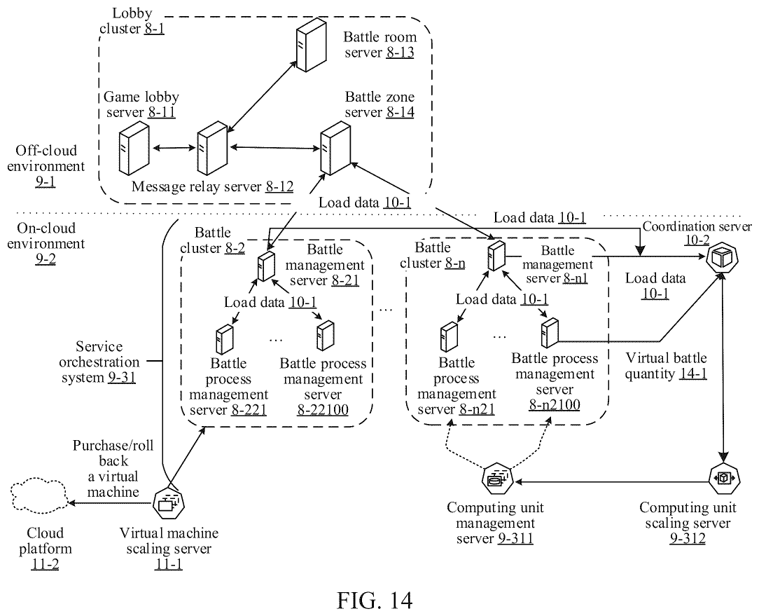

FIG. 13 is an interaction diagram of downscaling an exemplary virtual machine according to an embodiment of this application. As shown in FIG. 13, the virtual machine is downscaled by performing downscaling tasks among a computing unit scaling server 9-312, a scheduler 12-1, a virtual machine scaling server 11-1, and a cloud platform 11-2, including operation 1301 to operation 1306. The operations are respectively described below.

Operation 1301: The scheduler 12-1 deletes a computing unit through the computing unit scaling server 9-312.

Operation 1302: The virtual machine scaling server 11-1 detects a virtual machine C (referred to as a to-be-downscaled second resource) without the computing unit running from the scheduler 12-1, and starts downscaling the virtual machine.

Operation 1303: The virtual machine scaling server 11-1 sets the virtual machine C to a non-schedulable state (referred to as a second scheduling stop state).

Operation 1304: The virtual machine scaling server 11-1 rolls back the virtual machine C to the cloud platform 11-2 when a duration for which the virtual machine C is in the non-schedulable state reaches a specified duration.

Operation 1305: The cloud platform 11-2 transmits a rollback success notification to the virtual machine scaling server 11-1.

Operation 1306: The virtual machine scaling server 11-1 ends downscaling the virtual machine based on the rollback success notification.

During downscaling of a pod, to implement lossless downscaling, the virtual machine is configured to transmit a virtual battle quantity corresponding to the pod to a coordination server 10-2.

Based on FIG. 11, FIG. 14 is a schematic diagram of exemplary lossless downscaling according to an embodiment of this application. FIG. 14 exemplarily shows that a battle process management server 8-n2100 transmits a virtual battle quantity 14-1 (referred to as a computing task quantity) corresponding to a pod to a coordination server 10-2, so that the coordination server 10-2 determines, based on the virtual battle quantity 14-1, whether to remove the pod on the battle process management server 8-n2100.

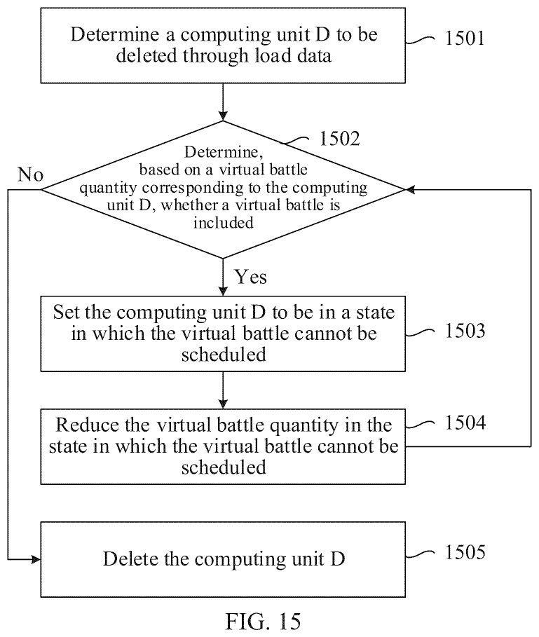

Based on FIG. 14, FIG. 15 is a schematic diagram of an exemplary lossless downscaling process according to an embodiment of this application. As shown in FIG. 15, the exemplary lossless downscaling process includes operation 1501 to operation 1505. The operations are respectively described below.

Operation 1501: Determine a computing unit D (referred to as a to-be-downscaled first resource) to be deleted through load data.

Operation 1502: Determine, based on a virtual battle quantity corresponding to the computing unit D, whether a virtual battle is included, if so, perform operation 1503, and if not, perform operation 1505.

Operation 1503: Set the computing unit D to be in a state in which the virtual battle cannot be scheduled.

Operation 1504: Reduce the virtual battle quantity in the state in which the virtual battle cannot be scheduled, and perform operation 1502.

Operation 1505: Delete the computing unit D.

Herein, a scheduler 12-1, the virtual machine scaling server 11-1, a task platform 12-2, and a computing unit scaling server 9-312 of a service orchestration system 9-31 jointly correspond to the foregoing device for resource processing.

In this embodiment of this application, lossless automatic scaling of virtual battle-related resources is implemented on the cloud by deploying the servers (including the DScenter and the DSagent) associated with the virtual battle on the cloud, thereby reducing resource consumption of the virtual battle in a stable condition and increasing a resource utilization rate.

An exemplary structure of the apparatus 455 for resource processing provided in the embodiments of this application implemented as a software module is further described below. In some embodiments, as shown in FIG. 2, software modules in the apparatus 455 for resource processing stored in the memory 450 may include:
a quantity determination module 4551, configured to determine a target resource quantity of a first resource based on current load data of the first resource, the first resource being a resource scheduling unit configured to perform a computing task;
a first scaling module 4552, configured to scale the first resource based on the target resource quantity and a current resource quantity of the first resource, the scaling the first resource including upscaling the first resource or downscaling the first resource; and
a second scaling module 4553, configured to scale a second resource based on a scheduling state of a scaled first resource, the second resource being configured for scheduling the first resource, and the scaling a second resource including upscaling the second resource or downscaling the second resource.

In this embodiment of this application, the current load data includes at least one of the following: the current resource quantity, a current total load value, and a current loaded value, the current total load value referring to a total resource value corresponding to the first resource, and the current loaded value referring to a used resource value corresponding to the first resource. When the current load data includes the current resource quantity, the current total load value, and the current loaded value, the quantity determination module 4551 is further configured to: determine a ratio of the current loaded value to the current total load value as a current load rate; and obtain the target resource quantity of the first resource that is positively correlated with the current resource quantity, positively correlated with the current load rate, and negatively correlated with a specified load rate.

In this embodiment of this application, the quantity determination module 4551 is further configured to: obtain a load rate comparison result between the current load rate and a specified load rate range; and obtain the target resource quantity of the first resource that is positively correlated with the current resource quantity, positively correlated with the current load rate, and negatively correlated with the specified load rate when the load rate comparison result indicates that the current load rate is outside the specified load rate range.

In this embodiment of this application, the apparatus 455 for resource processing further includes a data receiving module 4554, configured to receive the current load data transmitted by at least one first service device through a second service device, the first service device being configured to perform at least one computing task through the first resource, the second service device being configured to control the first service device, the second service device being further configured to transmit the current load data to a business serving device, the business serving device being configured to determine the first resource corresponding to a new computing task based on the current load data.

In this embodiment of this application, the first scaling module 4552 is further configured to: obtain a resource quantity difference between the target resource quantity and the current resource quantity of the first resource; upscale the first resource based on the resource quantity difference when the target resource quantity is greater than the current resource quantity; and downscale the first resource based on the resource quantity difference when the target resource quantity is less than the current resource quantity.

In this embodiment of this application, the first scaling module 4552 is further configured to: determine each to-be-downscaled first resource based on the resource quantity difference; and perform the following process for each to-be-downscaled first resource: deleting the to-be-downscaled first resource when a computing task quantity corresponding to the to-be-downscaled first resource is less than a specified quantity, the computing task quantity being data transmitted by the first service device.

In this embodiment of this application, the first scaling module 4552 is further configured to: adjust a state of the to-be-downscaled first resource to a first scheduling stop state when the computing task quantity corresponding to the to-be-downscaled first resource is greater than or equal to the specified quantity, the first scheduling stop state being configured for reducing the computing task quantity; and delete the to-be-downscaled first resource when the computing task quantity is reduced to less than the specified quantity by adjusting the state of the to-be-downscaled first resource to the first scheduling stop state.

In this embodiment of this application, the second scaling module 4553 is further configured to: upscale the second resource based on an unscheduled quantity when the scheduling state of the scaled first resource includes an unscheduled state, the unscheduled quantity referring to a quantity of first resources in the unscheduled state; and obtain the second resource whose scheduling quantity is less than a specified scheduling quantity when the scheduling states of the scaled first resources are all a scheduled state, and downscale the second resource based on the obtained second resource, the scheduling quantity referring to a quantity of first resources scheduled on the second resource.

In this embodiment of this application, the second scaling module 4553 is further configured to: determine a to-be-upscaled quantity based on the unscheduled quantity and a scheduling relationship between the first resource and the second resource, and obtain the to-be-upscaled quantity of to-be-upscaled second resources from each idle second resource of a resource library; and perform the following processes for each of the to-be-upscaled second resources: initializing the to-be-upscaled second resource to obtain an initial second resource; preprocessing the initial second resource based on the first resource in the unscheduled state, to obtain a to-be-scheduled second resource; and scheduling the first resource in the unscheduled state to the to-be-scheduled second resource.

In this embodiment of this application, the second scaling module 4553 is further configured to: perform the following processes for each to-be-downscaled second resource among the obtained second resources: adjusting a state of the to-be-downscaled second resource to a second scheduling stop state, the second scheduling stop state indicating a state in which scheduling of the first resource is stopped; determining the to-be-downscaled second resource as an idle second resource when a duration in the second scheduling stop state is greater than a specified duration; and moving the idle second resource to a resource library.

In this embodiment of this application, the computing task includes at least one of the following: a virtual battle in a virtual scene and a transaction task. The apparatus 455 for resource processing further includes a task execution module 4555, configured to: obtain the computing task based on a computing task operation; associate the computing task with the first resource; and perform the computing task based on scheduling of the first resource on the second resource.

An embodiment of this application provides a computer program product, the computer program product including computer-executable instructions or a computer program, the computer-executable instructions or the computer program being stored in a computer-readable storage medium. A processor of an electronic device reads the computer-executable instructions or the computer program from the computer-readable storage medium. The processor executes the computer-executable instructions or the computer program, so that the electronic device performs the foregoing method for resource processing according to the embodiments of this application.

An embodiment of this application provides a non-transitory computer-readable storage medium, having computer-executable instructions or a computer program stored therein, the computer-executable instructions or the computer program, when executed by a processor, causing the processor to perform the method for resource processing provided in the embodiments of this application, for example, the method for resource processing shown in FIG. 3.

In some embodiments, the computer-readable storage medium may be a memory such as a ferroelectric RAM (FRAM), a ROM, a flash memory, a magnetic surface memory, a compact disc, or a compact disc ROM (CD-ROM), or may be various devices including one or any combination of the foregoing memories.

In some embodiments, the computer-executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or other units suitable for use in a computing environment.

In an example, the computer-executable instruction may but may not necessarily correspond to a file in a file system, may be stored in a part of the file for storing other programs or data, for example, stored in one or more scripts in a hypertext markup language (HTML) document, stored in a single file specially used for the discussed program, or stored in a plurality of collaborative files (for example, files storing one or more modules, a subprogram, or a code part).

In an example, the computer-executable instruction may be deployed on one electronic device for execution (in this case, the electronic device is a device for resource processing), executed on a plurality of electronic devices located at a location (in this case, the plurality of electronic devices located at the location are the devices for resource processing), or executed on a plurality of electronic devices distributed at a plurality of locations and interconnected through a communication network (in this case, the plurality of electronic devices distributed at the plurality of locations and interconnected through the communication network are the devices for resource processing).

The embodiments of this application relate to related data such as current load data. User permission or consent needs to be obtained when the embodiments of this application are applied to specific products or technologies, and collection, use, and processing of the related data need to comply with relevant laws, regulations, and standards of relevant countries and regions.

Based on the above, in the embodiments of this application, when the first resource is scheduled to the second resource, and the computing task is performed through the first resource, the target resource quantity is determined based on the current load data of the first resource, the scaling of the first resource is implemented based on the target resource quantity and the current resource quantity of the first resource, and the second resource is scaled based on the scheduling state of the scaled first resource as a linked operation, thereby implementing real-time automatic scaling of the first resource and the second resource, so that the computing task can match the first resource and the second resource in quantity. Therefore, resource redundancy and resource waste are reduced, thereby reducing resource consumption and increasing the resource utilization rate. In addition, the downscaling of the first resource is triggered only when the computing task quantity is less than the specified quantity, so as to implement lossless downscaling of the first resource and further improve stability of business execution.

The foregoing descriptions are merely embodiments of this application and are not intended to limit the protection scope of this application. Any modification, equivalent replacement, or improvement made within the spirit and principle of this application falls within the protection scope of this application.

What is claimed is:

1. A method for optimizing computing resource performed by an electronic device, the method comprising:
determining a current resource quantity of a first resource based on current load data of the first resource and a target resource quantity of the first resource in connection with performing a computing task;
scaling the first resource based on a comparison of the target resource quantity and the current resource quantity of the first resource, the scaling the first resource comprising upscaling the first resource or downscaling the first resource; and
scaling a second resource based on a scheduling state of the scaled first resource, the scaling a second resource comprising upscaling the second resource or downscaling the second resource, wherein the scheduling state of the first resource refers to a scheduling condition of the first resource on the second resource, including that scheduling has been completed on the second resource and scheduling has not been completed on the second resource.

2. The method according to claim 1, wherein the current load data comprises at least one of the following: the current resource quantity, a current total load value, and a current loaded value, the current total load value referring to a total resource value corresponding to the first resource, and the current loaded value referring to a used resource value corresponding to the first resource; and
the determining a target resource quantity of the first resource in connection with performing a computing task comprises:
determining a ratio of the current loaded value to the current total load value as a current load rate; and
obtaining the target resource quantity of the first resource that is positively correlated with the current resource quantity, positively correlated with the current load rate, and negatively correlated with a specified load rate.

3. The method according to claim 2, wherein after the determining a ratio of the current loaded value to the current total load value as a current load rate, the method further comprises:
obtaining a load rate comparison result between the current load rate and a specified load rate range; and
the obtaining the target resource quantity of the first resource that is positively correlated with the current resource quantity, positively correlated with the current load rate, and negatively correlated with a specified load rate comprises:
obtaining the target resource quantity of the first resource that is positively correlated with the current resource quantity, positively correlated with the current load rate, and negatively correlated with the specified load rate when the load rate comparison result indicates that the current load rate is outside the specified load rate range.

4. The method according to claim 1, wherein before the determining a target resource quantity of a first resource based on current load data of the first resource, the method further comprises:
receiving the current load data transmitted by at least one first service device through a second service device, the first service device being configured to perform at least one computing task through the first resource, the second service device being configured to control the first service device to transmit the current load data to a business serving device, the business serving device being configured to determine the first resource corresponding to a new computing task based on the current load data.

5. The method according to claim 1, wherein the scaling the first resource based on a comparison of the target resource quantity and the current resource quantity of the first resource comprises:
obtaining a resource quantity difference between the target resource quantity and the current resource quantity of the first resource;
upscaling the first resource based on the resource quantity difference when the target resource quantity is greater than the current resource quantity; and
downscaling the first resource based on the resource quantity difference when the target resource quantity is less than the current resource quantity.

6. The method according to claim 5, wherein the downscaling the first resource based on the resource quantity difference comprises: determining each to-be-downscaled first resource based on the resource quantity difference; and
performing the following process for each to-be-downscaled first resource:
deleting the to-be-downscaled first resource when a computing task quantity corresponding to the to-be-downscaled first resource is less than a specified quantity, the computing task quantity being data transmitted by the first service device.

7. The method according to claim 1, wherein the scaling a second resource based on a scheduling state of the scaled first resource comprises:
upscaling the second resource based on an unscheduled quantity, the unscheduled quantity referring to a quantity of first resources whose scheduling has not been completed on the second resource; and
obtaining the second resource whose scheduling quantity is less than a specified scheduling quantity when the scheduling of the scaled first resources has been completed on the second resource, and downscaling the second resource based on the obtained second resource, the scheduling quantity referring to a quantity of first resources scheduled on the second resource.

8. The method according to claim 7, wherein the downscaling the second resource based on the obtained second resource comprises:
performing the following processes for each to-be-downscaled second resource among the obtained second resources:
adjusting a state of the to-be-downscaled second resource to a second scheduling stop state, the second scheduling stop state indicating a state in which scheduling of the first resource is stopped;
determining the to-be-downscaled second resource as an idle second resource when a duration in the second scheduling stop state is greater than a specified duration; and
moving the idle second resource to a resource library.

9. The method according to claim 1, wherein the computing task comprises at least one of the following: a virtual battle in a virtual scene and a transaction task.
the method further comprises: associating the computing task with the first resource; and
performing the computing task based on the scheduling of the scaled first resource on the scaled second resource.

10. An electronic device, comprising:
a memory, configured to store computer-executable instructions; and
a processor, configured to implement a method for optimizing computing resource when executing the computer-executable instructions stored in the memory, the method including:
determining a current resource quantity of a first resource based on current load data of the first resource and a target resource quantity of the first resource in connection with performing a computing task;
scaling the first resource based on a comparison of the target resource quantity and the current resource quantity of the first resource, the scaling the first resource comprising upscaling the first resource or downscaling the first resource; and
scaling a second resource based on a scheduling state of the scaled first resource, the scaling a second resource comprising upscaling the second resource or downscaling the second resource, wherein the scheduling state of the first resource refers to a scheduling condition of the first resource on the second resource, including that scheduling has been completed on the second resource and scheduling has not been completed on the second resource.

11. The electronic device according to claim 10, wherein the current load data comprises at least one of the following: the current resource quantity, a current total load value, and a current loaded value, the current total load value referring to a total resource value corresponding to the first resource, and the current loaded value referring to a used resource value corresponding to the first resource; and
the determining a target resource quantity of the first resource in connection with performing a computing task comprises:
determining a ratio of the current loaded value to the current total load value as a current load rate; and
obtaining the target resource quantity of the first resource that is positively correlated with the current resource quantity, positively correlated with the current load rate, and negatively correlated with a specified load rate.

12. The electronic device according to claim 11, wherein after the determining a ratio of the current loaded value to the current total load value as a current load rate, the method further comprises:
obtaining a load rate comparison result between the current load rate and a specified load rate range; and
the obtaining the target resource quantity of the first resource that is positively correlated with the current resource quantity, positively correlated with the current load rate, and negatively correlated with a specified load rate comprises:
obtaining the target resource quantity of the first resource that is positively correlated with the current resource quantity, positively correlated with the current load rate, and negatively correlated with the specified load rate when the load rate comparison result indicates that the current load rate is outside the specified load rate range.

13. The electronic device according to claim 10, wherein before the determining a target resource quantity of a first resource based on current load data of the first resource, the method further comprises:
receiving the current load data transmitted by at least one first service device through a second service device, the first service device being configured to perform at least one computing task through the first resource, the second service device being configured to control the first service device to transmit the current load data to a business serving device, the business serving device being configured to determine the first resource corresponding to a new computing task based on the current load data.

14. The electronic device according to claim 10, wherein the scaling the first resource based on a comparison of the target resource quantity and the current resource quantity of the first resource comprises:
obtaining a resource quantity difference between the target resource quantity and the current resource quantity of the first resource;
upscaling the first resource based on the resource quantity difference when the target resource quantity is greater than the current resource quantity; and
downscaling the first resource based on the resource quantity difference when the target resource quantity is less than the current resource quantity.

15. The electronic device according to claim 14, wherein the downscaling the first resource based on the resource quantity difference comprises:
determining each to-be-downscaled first resource based on the resource quantity difference; and
performing the following process for each to-be-downscaled first resource:
deleting the to-be-downscaled first resource when a computing task quantity corresponding to the to-be-downscaled first resource is less than a specified quantity, the computing task quantity being data transmitted by the first service device.

16. The electronic device according to claim 10, wherein the scaling a second resource based on a scheduling state of the scaled first resource comprises:
upscaling the second resource based on an unscheduled quantity, the unscheduled quantity referring to a quantity of first resources whose scheduling has not been completed on the second resource; and
obtaining the second resource whose scheduling quantity is less than a specified scheduling quantity when the scheduling of the scaled first resources has been completed on the second resource, and downscaling the second resource based on the obtained second resource, the scheduling quantity referring to a quantity of first resources scheduled on the second resource.

17. The electronic device according to claim 16, wherein the downscaling the second resource based on the obtained second resource comprises:
performing the following processes for each to-be-downscaled second resource among the obtained second resources:
adjusting a state of the to-be-downscaled second resource to a second scheduling stop state, the second scheduling stop state indicating a state in which scheduling of the first resource is stopped;
determining the to-be-downscaled second resource as an idle second resource when a duration in the second scheduling stop state is greater than a specified duration; and
moving the idle second resource to a resource library.

18. The electronic device according to claim 10, wherein the computing task comprises at least one of the following: a virtual battle in a virtual scene and a transaction task.
the method further comprises:
associating the computing task with the first resource; and
performing the computing task based on the scheduling of the scaled first resource on the scaled second resource.

19. A non-transitory computer-readable storage medium, having computer-executable instructions stored therein, the computer-executable instructions, when executed by a processor of an electronic device, implementing a method for optimizing computing resource including:
determining a current resource quantity of a first resource based on current load data of the first resource and a target resource quantity of the first resource in connection with performing a computing task;
scaling the first resource based on a comparison of the target resource quantity and the current resource quantity of the first resource, the scaling the first resource comprising upscaling the first resource or downscaling the first resource; and
scaling a second resource based on a scheduling state of the scaled first resource, the scaling a second resource comprising upscaling the second resource or downscaling the second resource, wherein the scheduling state of the first resource refers to a scheduling condition of the first resource on the second resource, including that scheduling has been completed on the second resource and scheduling has not been completed on the second resource.

20. The non-transitory computer-readable storage medium according to claim 19, wherein the computing task comprises at least one of the following: a virtual battle in a virtual scene and a transaction task.
the method further comprises:
associating the computing task with the first resource; and
performing the computing task based on the scheduling of the scaled first resource on the scaled second resource.
